(19) United States
(12) Patent Application Publication
(10) Pub. No.: US 2019/0156334 A1
(43) Pub. Date: May 23, 2019

(54) SYSTEM AND METHOD FOR PROVIDING ANONYMOUS PAYMENTS

(71) Applicant: Robert John Mars, Broomfield, CO (US)

(72) Inventor: Robert John Mars, Broomfield, CO (US)

(21) Appl. No.: 15/820,484

(22) Filed: Nov. 22, 2017

(51) Int. Cl. G06Q 20/38; G06Q 20/42; G06Q 20/32

(52) U.S. Cl. CPC G06Q 20/383; G06Q 20/385; G06Q 20/327; G06Q 20/42

(57) ABSTRACT

Methods and systems are disclosed for enabling anonymous financial transactions to be conducted using mobile devices, such as smartphones and tablet PCs. Preferred embodiments of the system comprise an entitlement system that validates information to enable anonymous payments and receipt of payments using mobile devices. Payments may be initiated by communicating a desire to make a payment to a nearby payee. Preferred embodiments utilize short-range communication to form an electronic agreement between the payer and payee as to the payment of an amount from the payer to the payee. Further, the system uses the methods described herein for completing the transactions in an anonymous manner, preventing disclosure of the identities of both the Payer and Payee.

### FIELD OF THE INVENTION

Methods and systems are disclosed for enabling anonymous financial transactions to be conducted using mobile devices, such as smartphones and tablet PCs. Preferred embodiments of the system comprise an entitlement system that validates information to enable anonymous payments and receipt of payments using mobile devices. Payments may be initiated by communicating a desire to make a payment to a nearby payee. Preferred embodiments utilize short-range communication to form an electronic agreement between the payer and payee as to the payment of an amount from the payer to the payee. Further, the system uses the methods described herein for completing the transactions in an anonymous manner, preventing disclosure of the identities of both the Payer and Payee.

### BACKGROUND

The use of mobile devices to conduct person to person and person to business financial transactions is growing in popularity. The most common forms involve sending a payment to a payee using the payee's cellular phone number, email address, or an alias. All of these methods depend on the payer having personal information about the payee and vice versa. There are times when a person may want to pay or gift another person or organization anonymously without revealing information about themselves, much the same way as the exchange of cash between two people may provide anonymity. For example, a person may want to anonymously give a tip to just a specific waiter in a restaurant using electronic means with their consent, but without exchanging personal information. Another example is a person or business may want to anonymously give a monetary gift to a charity organization. Accordingly, there is a need for a new method of conducting anonymous financial transactions using mobile devices.

Credit card fraud is at an all-time high, topping $24.71 billion in 2016 as estimated in the Nilson Report. ACI Worldwide estimates that over 46% of Americans have had their credit card information compromised in the past 5 years. Identify theft occurs 16% of the time in relation to credit card fraud and 6% of the time in relation to bank fraud. The data imprinted on or embedded in credit and debit cards is vulnerable to fraud every time a card is handed over to another person, scanned, swiped, copied, or entered into a form. Accordingly, there is a need for a new method of conducting financial transactions anonymously without the use of physical cards by using mobile devices.

Therefore, there is a need in the art for a system and method for conducting financial transactions anonymously without the use of physical cards, such as through the use of mobile computing devices. Further, there is a need in the art for a replacement for the requirement that a physical credit card reader, scanner, or imprinter be present when making card-based payments.

### BRIEF SUMMARY OF THE INVENTION

According to an embodiment of the present invention, provide a system and method for conducting financial transactions anonymously without the use of physical cards. Further, preferred embodiments of the present invention replace the need for having card readers, scanners or the like, as vulnerable card information and data are stored securely in a safe storage medium (e.g., PCI DSS compliant data store) accessible only to the payment processing and entitlement systems when executing a payment using mobile devices.

Embodiments of the invention are directed to methods and systems for conducting anonymous Person-to-Person (P2P), Person-to-Business (P2B), Person-to-Organization, and Business-to-Business (B2B), Business-to-Person, Organization-to-Business, Business-to-Organization payments, or other types of anonymous payments (including any combination thereof), using mobile devices. Anonymous payments may take place in any suitable context, may involve payments for goods or services (or any combination thereof), or without any return consideration of goods, services or otherwise, such as a payment of an outstanding debt or a gift.

One embodiment of the invention is directed to a method, and a system configured to perform the method. The method comprises the registration of a payer or payee into an entitlement system thereby enabling subsequent anonymous payment or receipt of funds electronically using a mobile device. The payer and payee each create an entitlement account online with an entitlement system and enter personal data and payment account data sufficient to enable payment and receipt of funds electronically by corresponding financial transaction system. The personal data and payment account data are securely sent to a financial transaction system or payment processing solution provider for safe storage (e.g., in a PCI DSS compliant persistent storage) and are bound to the corresponding payer or payee entitlement account through publically-safe data and identifiers provided or recognized by the financial transaction system or payment solution provider. The publically-safe data and identifiers are subsequently used for payments made by the payer to the payee.

Another embodiment of the invention is directed to a method, and a system configured to perform the method. The method comprises a transmission of a payment intent message from a payer mobile device to a payee mobile device and a transmission in response to the payment intent message of a corresponding payment acceptance message from the payee mobile device to the payer mobile device. The payment intent message comprises a payment amount and a universally unique identifier (UUID), the latter of which may be used for subsequent verification and authentication. The payer initiates an anonymous payment to a payee by verbally inviting, or through other communication means (e.g., invitation via interaction on a mobile computing device), the payee to an anonymous payment by the payer to the payee. The payer mobile device is configured to send a payment intent message and receive a payment acceptance message. The payee mobile device is configured to receive a payment intent message and sent a payment acceptance message. The payer and payee position their mobile devices in close proximity to one another to enable transmission of the payment intent message from the payer mobile device to the payee mobile device using a short-range data communication capability. The payer and payee mobile devices detect or enter into short-range data communication and engage in the transfer of the payment intent message from the payer mobile device to the payee mobile device. The payer and payee mobile devices each notify the payer and payee, respectively, of the payment amount to be paid. The payee approves the payment amount and the payee mobile device subsequently transmits a payment acceptance message from the payee mobile device to the payer mobile device using the aforementioned short-range data communication technique. The payer and payee mobile devices then each indicate that the payment is pending. The verbalization (or initiating through interaction with a mobile computing device or other computing device) and acceptance of a payment intent and the exchange of a payment intent message and the corresponding payment acceptance message are subsequently referred to herein as a “payment handshake.”

Another embodiment of the invention is directed to a method, and a system configured to perform the method. The method comprises a transmission of a payment request message from a payee mobile device to a payer mobile device and a transmission in response to the payment request message of a corresponding payment intent message from the payer mobile device to the payee mobile device. The payee initiates an anonymous payment from a payer by verbally inviting, or through other communication means (e.g., confirmation via interaction on a mobile computing device), the payer to an anonymous payment by the payer to the payee. The payee mobile device is configured to send a payment request message and receive a payment intent message. The payer mobile device is configured to receive a payment request message and send a payment intent message. The payee and payer position their mobile devices in close proximity to one another to enable transmission of the payment request message from the payee mobile device to the payer mobile device using a short-range data communication capability. The payee and payer mobile devices detect the short-range data communication signal and engage in the transfer of the payment request message from the payee mobile device to the payer mobile device. The payee and payer mobile devices each notify the payee and payer, respectively, of the payment amount to be paid. The payer approves the requested payment amount and the payer mobile device subsequently transmits a payment intent message from the payee mobile device to the payee mobile device using the aforementioned short-range data communication technique. The payee and payer mobile devices then each indicate the payment is pending.

Another embodiment of the invention is directed to a method, and a system configured to perform the method. The method comprises the secure sending of separate payment and acceptance tokens by the payer and payee mobile devices, respectively, to an entitlement system after the payment handshake has completed, and the verification, correlation, and formulation of a payment transaction message by the entitlement system using the payment and acceptance tokens. The payment token is sent by the payer mobile device to an entitlement system when Internet access becomes available to the payer mobile device. The acceptance token is sent by the payee mobile device to an entitlement system when Internet access becomes available to the payee mobile device. Upon receipt of the payment token and the acceptance token by the entitlement system(s), the entitlement system verifies the tokens for legitimacy, correlates the tokens using the embedded matching Universally Unique Identifier (UUID) in each of the tokens, looks up in the entitlement database the publicly-safe data and identifier information for the payer and payee using the payer name, payee name, payment method if the payer has more than one registered payment method, and payment destination if the payee has more than one registered payment receipt method, and formulates a payment transaction message using the minimally required publicly-safe data for conducting the transaction. The payment transaction message is then sent to the financial transaction system or the payment solution provider system. Unsuccessful verification or correlation of the tokens or the look up of the corresponding payer, payee, and payment method information from the entitlement database results in a rejection of the payment. Note that this method applies whether the payer or payee initiated the payment handshake.

Another embodiment of the invention is directed to a method, and a system configured to perform the method. The method comprises the transmittal of the payment transaction to a financial processing system or a payment solution provider system to conduct the financial payment transaction and to respond with an approval or denial of the payment. An approval or denial message is sent by a financial processing system to an entitlement system or a payment solution provider system and in turn to an entitlement system. The entitlement system then formulates a payment status message and sends it to the payer and payee mobile devices for notification to the payer and payee.

Other embodiments of the invention are directed to systems, smart devices (e.g., smart TVs), Internet of Things (IoT) devices, smart phones, smart speakers (e.g., AMAZON ECHO™, AMAZON DOT™, AMAZON SHOW™, GOOGLE HOME™, or APPLE HOMEPOD™), computer readable media, and devices adapted to implement the above methods or embodiments described herein. One of ordinary skill in the art would appreciate that there are numerous types of such devices that could be utilized in conjunction with the methodologies described and detailed herein.

These and other embodiments of the invention are described in further detail below.

### BRIEF DESCRIPTION OF THE DRAWINGS

FIG. 1 shows a block diagram of an anonymous payment system in accordance with one or more embodiments of the invention.

FIG. 2 shows a diagram of a mobile device in accordance with one or more embodiments of the invention.

FIG. 3 shows a diagram of a computing system in accordance with one or more embodiments of the invention.

FIG. 4 shows a flowchart of the creation of entitlement and payment accounts in accordance with one or more embodiments of the invention.

FIG. 5 shows a flowchart of the payment intent and acceptance process in accordance with one or more embodiments of the invention.

FIG. 6 shows a flowchart of the processing of a payment in accordance with one or more embodiments of the invention.

FIG. 7 shows a flowchart of the processing of a financial transaction in accordance with one or more embodiments of the invention.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principals of what is claimed, and those alternatives are contemplated for use with embodiments of the present invention.

Reference will now be made in detail to several embodiments, examples of which are illustrated in accompanying figures. It is noted that wherever practically similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principals described here.

Systems

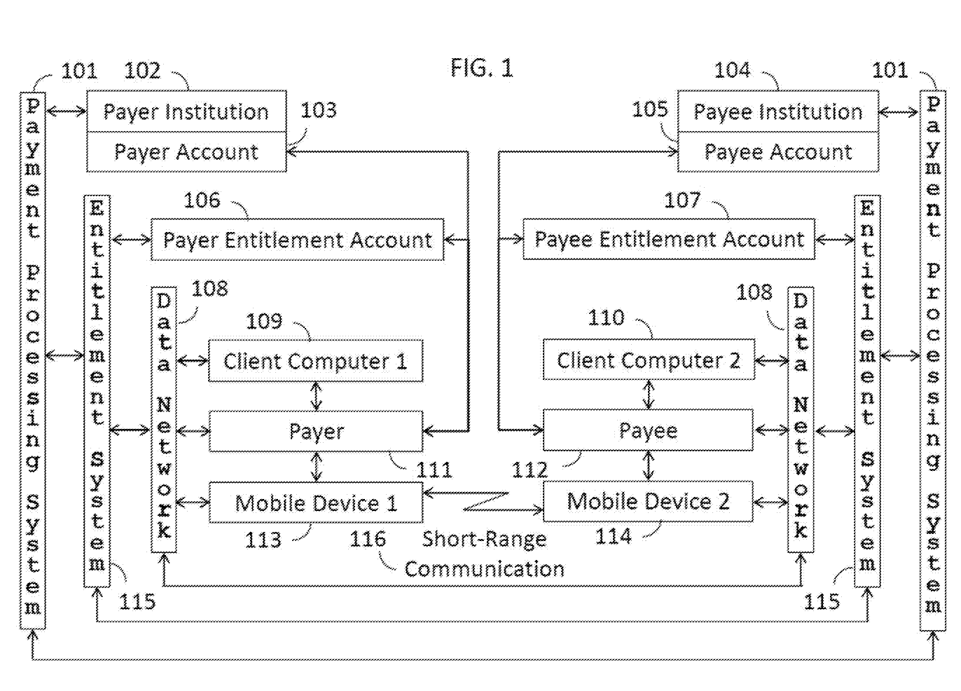

FIG. 1 shows a block diagram of a system that can be used in accordance with an embodiment of the invention. Embodiments of the invention may use some or all of the components shown in FIG. 1. Further, embodiments of the present invention may include additional or fewer components than those are shown in FIG. 1. Embodiments of the invention are well suited to a wide variety of computer network systems, and may be provided over numerous network topologies. Within this field, the configuration and management of large networks include networking devices (e.g., routers, switches, communications management platforms, firewalls), storage devices (local, remote, or any combination thereof), and computing devices (e.g., computers, mobile computing devices, servers) that are communicatively coupled to dissimilar computers and storage devices over a network, such as the Internet. One of ordinary skill in the art would appreciate that there are numerous configurations that could be utilized with embodiments of the present invention, and embodiments of the present invention are contemplated for use with any appropriate configuration and/or topology. Several of the entities in FIG. 1 are shown in duplicate to more clearly illustrate connectivity, but represent single entities.

The illustrated system includes a payer 111 and a mobile device 113 associated with the payer 111. The payer 111 has a payer account 103 at a payer institution 102 and a payer entitlement account 106 on an entitlement system 115. Likewise, the system includes a payee 112 and a separate mobile device 114 associated with the payee 112. The payee 112 has a payee account 105 at a payee institution 104 and a payee entitlement account 107 on an entitlement system 115. The system may also include a payer 111 client computer 109 and a payee 112 client computer 110, either of which may access a data network 108 (e.g., Internet) to communicate with an entitlement system 115.

The payer 111 mobile device 113 and the payee 112 mobile device 114 are each capable of communicating with one another using a short-range communication 116 technique. Short-range communication techniques include, but are not limited to, the use of Near Field Communication (NFC), Infrared, BLUETOOTH′, acoustics, WIFI DIRECT®, camera-based barcode scanning, and other medium for communicating data over relatively short distances. One of ordinary skill in the art would appreciate that there are numerous forms of short-range communication techniques that could be utilized with embodiments of the present invention, and embodiments of the present invention are contemplated for use with any appropriate short-range communication technique.

The payer institution 102 and the payee institution 104 may be one and the same financial institution in other embodiments of the invention.

In a preferred embodiment of the present invention, the payer institution 102 and payee institution 104 are typically banks that manage financial accounts for individuals, businesses, or any combination thereof. However, they could also be other kinds of organizations that provide digital wallets such as APPLE PAY′, GOOGLE WALLET, or PAYPAL′, or other means of electronic payment. One of ordinary skill in the art would appreciate that there are numerous types of payee and payer institutions that could be utilized with embodiments of the present invention, and embodiments of the present invention are contemplated for use with any appropriate institution.

The payer 111 and payee 112 are typically individuals, but may also be businesses, charities, non-profits, or other organizations that are capable of entering into financial payment transactions, or any combination thereof.

The payment processing system 101 may include, but is not limited to, data processing subsystems, server computers, networks, and operations used to support and deliver authorization services, clearing and settlement services. An example of a payment processing system may include, but is not limited to, VISA®. A server computer is typically a powerful computer or cluster of computers dedicated to providing a particular set of services to client computers or devices, which may also be server computers.

The payment processing system 101 may consist of all-in-one payment processing solutions providers such as BLUESNAP™ or PAYPAL™ that offer Application Programmer Interfaces (APIs) for processing credit card and debit card transactions, Automated Clearing House (ACH) transactions, and other types of financial transactions, or any combination thereof.

The entitlement system 115 may include server computers, networks, and operations used to support and manage payer entitlement accounts 106 and payee entitlement accounts 107 and provide data transfer and communication with payer mobile devices 113 and payer client computers 109, as well as payee mobile devices 114 and payee client computers 110.

A payer 111 may create, view or modify a payer entitlement account 106, profile data or payment methods metadata held within the payer entitlement account 106 using a web browser, application software (i.e., an “app”), or similar software running on a payer mobile device 113 or a payer client computer 109. Similarly, a payee 112 may create, view or modify a payer entitlement account 107, profile data or payment methods metadata held within the payee entitlement account 107 using a web browser, application software, or similar software running on a payee mobile device 114 or a payee client computer 110. The entitlement system 115 account data are stored in one or more databases managed by the entitlement system 115.

In a preferred embodiment of the present invention, the data network 108 is comprised of a communication medium consisting of any suitable combination of wired and/or wireless networks, including the Internet. One of ordinary skill in the art would appreciate that there are numerous types of communication mediums that could be utilized with embodiments of the present invention, and embodiments of the present invention are contemplated for use with any appropriate communication medium.

According to an embodiment of the present invention, a separate data network (not shown) may be operatively coupled to a payment processing system 101 to provide a communication pathway between an entitlement system 115 and a payment processing system 101. This data network may be embodied by a suitable combination of hardware and/or software known to those of ordinary skill in the art.

Payment methods may include, but are not limited to, credit cards, debit cards, bank account ACH/ECH data, PAYPAL™, digital wallets (including those that operate on standard and non-standard currencies, such as cryptocurrencies), or other forms of electronic payments, or any combination thereof. Payment method metadata are publicly-safe data that represent the underlying payment method data. For example, a payment method's metadata may be comprised of the payer's name, the last four digits of a payer credit card, the type of credit card (e.g., VISA), and the 5-digit zip code of the payer billing address, or any combination thereof. Another example of a payment method's metadata may be comprised of a payment account ID provided by a payment processing solution provider representing a payer's collection of payment methods.

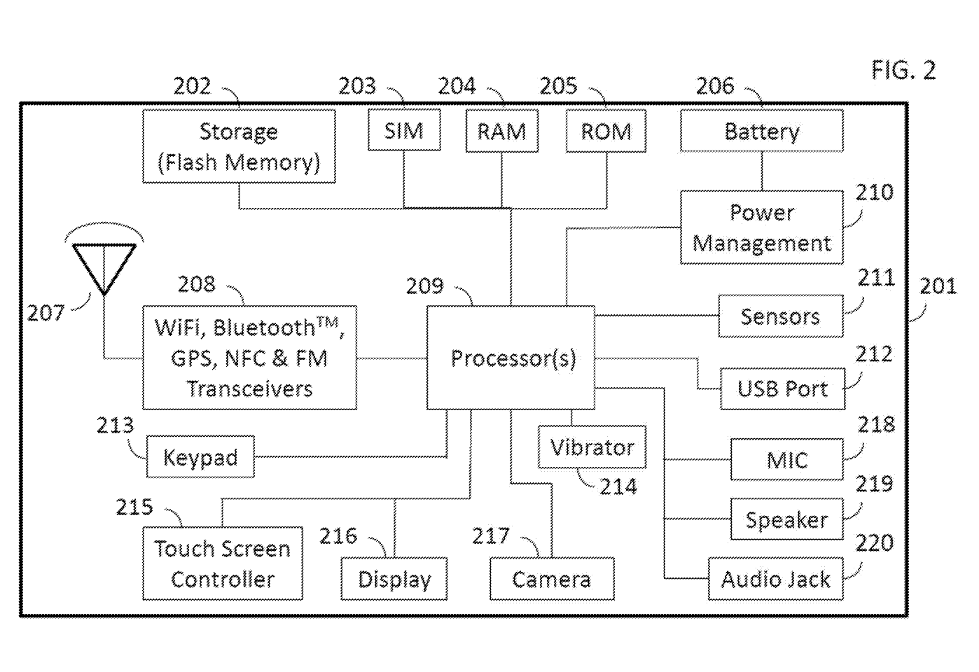

FIG. 2 shows a block diagram of the typical components or subsystems of a mobile device (e.g., a smartphone). Some or all of the components may be present in the payer 111 mobile device 113 or the payee 112 mobile device 114 illustrated in FIG. 1. One of ordinary skill in the art would appreciate that the number and type of components may vary from one mobile device to the next, and that there are any number of mobile devices that would function appropriately with embodiments of the present invention, and embodiments of the present invention are contemplated for use with any appropriate device.

According to an embodiment of the present invention, a mobile device may comprise a computer readable medium such as storage (e.g., flash memory) 202, a subscriber identity module or subscriber identification module (SIM) 203, random access memory (RAM 204), or ROM 205, and a body 201 as shown in FIG. 2. The computer readable medium may be present within the body or may be detachable from it, such as a micro SD card. The mobile device body 201 may be in the form of a plastic or metal casing, housing, or other structure. The storage 202 may be a memory that stores data and may be in any suitable form, including various forms of flash memory such as NAND or NOR, etc. The SIM 203 is an integrated circuit that is intended to securely store the international mobile subscriber identity (IMSI) number and its related key, which are used to identify and authenticate subscribers on mobile telephony devices.

According to an embodiment of the present invention, the computer readable medium may comprise code for performing any of the functions described herein. For example, it may comprise code for sending a payment intent message from a mobile device to another mobile device, code for receiving in response to the payment intent message a payment acceptance message, where the payment acceptance message is received by the originating mobile device; code for sending payment tokens and acceptance tokens to an entitlement server; and code for receiving a response from an entitlement server for confirmation or denial of payment.

According to an embodiment of the present invention a mobile device may further embed or provide an interface to one or more short-range communication 116 elements with an associated wireless transfer element, such as an antenna 207 for wireless data transmission and receipt, as well as WiFi, BLUETOOTH™, and NFC transceivers 208. Other forms of short-range communication 116 that are not radio frequency based and may be used include camera 217 based barcode display and scanning where an image may be encoded with information and displayed on one mobile device, scanned with a second mobile device's camera 217 and hence, transferred to the second mobile device, and decoded back to the original informational data.

Data and/or control instructions internal to a mobile device may be exchanged through the short-range communication element to another mobile device embedding or providing an interface to a short-range communication 116 element. Short-range communication data may be, but is not limited to, transfer or receipt in accordance with standardized protocol or data transfer mechanisms such as ISO 14443. The short-range communication 116 element is not limited to mobile device to mobile device communication and may also be used to communicate data and/or control instructions with an access device such as a POS terminal. Thus, the mobile device is capable of communicating and transferring data and/or control instructions, but is not limited to, using a cellular network, a mobile data network, or a short-range communications capability. One of ordinary skill in the art would appreciate that there are numerous types of short-range communications, and related components, that could be used with embodiments of the present invention, and embodiments of the present invention are contemplated for use with any such short-range communications and related components.

According to an embodiment of the present invention, the mobile device may also include a System on a Chip (SoC) or one or more processors 209 for processing the functions of the device including executing machine-readable instructions, accelerating graphics, converting digital to analog and analog to digital signals, or decoding and encoding data, and a display 216 to allow a payer or payee to view a payment amount, notifications, messages, and other information. The mobile device may further include input elements such as a touch screen 215, a virtual or physical keypad 213 (also known as a keyboard) to allow the payer 111 or payee 112 to input alphanumeric and other information into the device, a speaker 219 to allow the payer 111 or payee 112 to hear voice communication, music and sounds, and a microphone (MIC 218) to allow the payer 111 or payee 112 to transmit their voice through the mobile device. The mobile device may additionally include temperature, acceleration, magnetic field, barometric pressure, gravity, or orientation sensors 211, an audio jack 220 to plug in an earphone or earplug to listen to audio, a battery 206 for power storage, a vibrator 214 for notifications and user-feedback, a power management unit 210, and a USB port 212 for battery charging or transfer of data between the mobile device and external devices such as a computer.

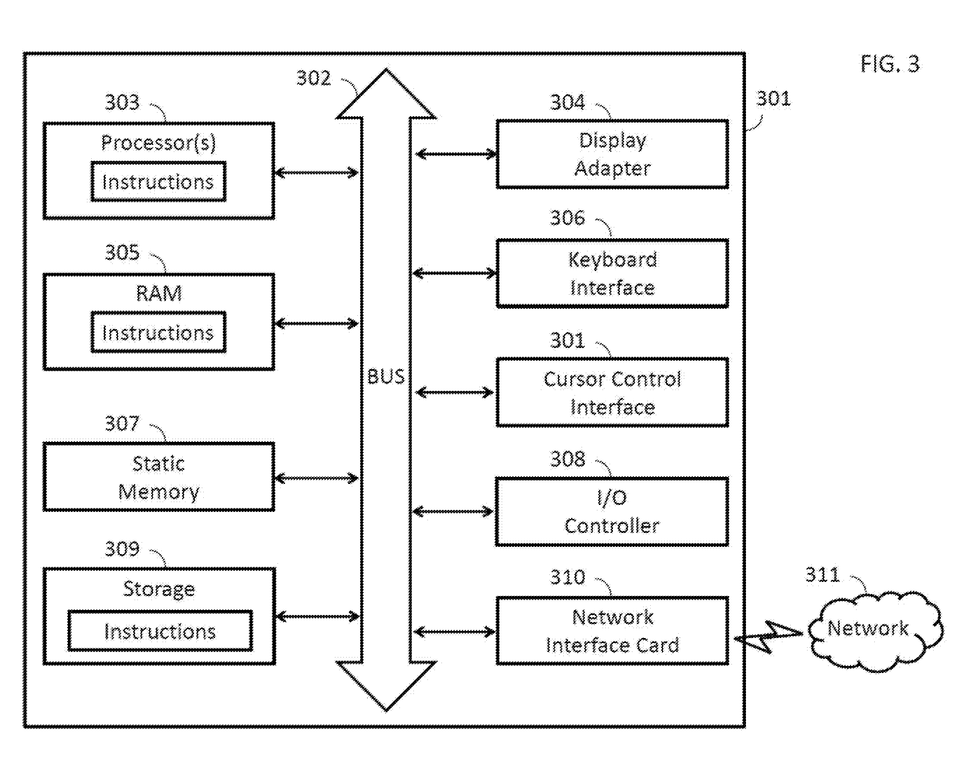

FIG. 3 shows a block diagram of the typical components or subsystems of a computer or computing device 301. Some or all of the components may be present in the payer client computer 109 or the payee client computer 110, the entitlement system 115 computers (e.g., server computers, client computers, blade systems, etc.), and payment processing system 101 computers, illustrated in FIG. 1. The subsystems shown in FIG. 3 are interconnected via a system bus 302. Additional subsystems such as a display adapter 304, keyboard interface 306, cursor control interface 301 may or may not be present depending on whether the computer is rack mounted as a blade server. A computer system may include internal storage 309 and/or external storage, such as a Storage Area Networks (SANs), connected through an I/O controller 308. Other peripherals such as a printer may be connected through the I/O controller 308 by any number of means known in the art. The system bus 302 interconnect allows the processor(s) 303 to communicate with each subsystem and to control the execution of instructions from Random Access Memory (RAM 305), the internal storage 309 unit, or external storage via the I/O controller 308 or Network Interface Card 310 (NIC), as well as the exchange of information between subsystems. The network interface card 310 or interface provides a communication medium, such as Ethernet, to communicate data and/or instructions to external devices or networks. The entitlement system 115 or payment processing system 101 may be comprised, in whole or in part, of virtual computers known as virtual machines, running on physical computers, or specialized subsets of a computer such as compute nodes, for more optimal computer resource allocation, or networking switches for data networking.

Account Registration

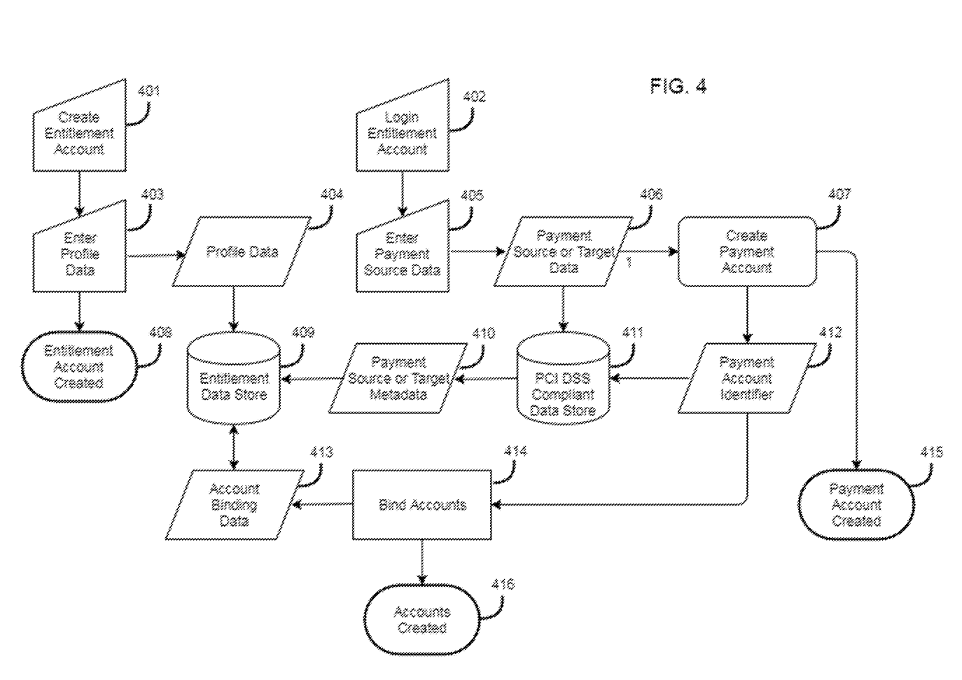

FIG. 4 shows a flowchart of a method for payer 111 or payee 112 registration in an entitlement system that may be used as a preferred embodiment of the invention. A payer 111 or payee 112 may register in the entitlement system 115 in any suitable manner by first creating an entitlement account 401. For example, the payer 111 and payee 112 may register in the entitlement system 115 by navigating a web browser to the entitlement system 115 web site using a client computer 109, 110 or mobile device 113, 114, or through a software application on a mobile device 113, 114 as illustrated in FIG. 1. A payer 111 or payee 112 enters profile data 403, such as account holder's name, address, and phone number, to create an entitlement account 408 and enters payment source or target data 405, such as credit card, debit card, bank account, or electronic wallet information, to create a payment account 407. A payment source 406 may be restricted to only debiting a payment account and a payment target 406 may be restricted to only crediting a payment account. A payment source and target 406 may be one and the same, meaning they have the same underlying payment method (e.g., an electronic wallet, debit card or bank account). The entitlement account 408 and payment account 415 may then be bound 414 to one another using the payment account identifier 412 and other account binding data 413 stored in the entitlement data store 409.

The profile data 404 are stored by the entitlement system 115 server computers in an entitlement data store 409 for later use by the entitlement system 115 and are accessible by the payer 111 or payee 112 for subsequent viewing and modification by logging into their entitlement account 402 using a web browser or software application.

The entitlement system 115 may identify the payer 111 and payee 112 using profile data, such as a payer or payee name, or by using the International Mobile Subscriber Identity (IMSI) number in their mobile device. In other embodiments, there can be separate entitlement data store for storing profile information and a separate data store for storing payment source or target metadata 410.

The payment source or target data 406 are securely stored in a safe storage medium (e.g., PCI DSS compliant data store) 411, which may be managed by a payment processing solution provider, such as BLUESNAP™ or PAYPAL™, or a payment processing system, such as VISA®. The payment source or target data 406 also have associated payment source or target metadata 410, such as an electronic wallet ID or the last 4 digits of a credit card, debit card, or bank account, that are stored by the entitlement system 115 server computers with the payer 111 or payee 112 payment account identifier 412 in the entitlement data store 409. The payment source or target metadata 410 are such that they do not require PCI DSS Compliance. These metadata may be used in subsequent payment processing fulfillment to identify and utilize the payer 111 or payee 112 payment source or target data 406.

The payer 111 or payee 112 must create an entitlement account 401 to be registered in the entitlement system and have successfully entered the data for at least one payment source or target 405 before it is possible for them to make or receive anonymous payments using the embodiments of this invention. More than one payment source or target 406 may be entered for a payer 111 or payee 112 entitlement account 408.

The payer 111 or payee 112 may login to their entitlement account 402 after creating an entitlement account 408 to enter additional or alter existing profile data 404.

The payer 111 or payee 112 may be prompted to enter credentials such as a preconfigured Personal Identification Number (PIN), password, swipe pattern, or touch a finger print reader to match a preregistered finger print while logging in to gain entry to their entitlement account 408 on a mobile device 113, 114 or a client computer 109, 110.

The payer 111 or payee 112 may login to their entitlement account 402 to enter additional or alter existing payment source or target data 406.

The first time a payer 111 or payee 112 enters new payment source or target data 405, the entitlement system 115 may relay the payment source or target data 406 to a payment processing solution provider for safe storage medium (e.g., in a PCI DSS Compliant Data Store) and to automatically create a payment account 407 held by the payment processing solution provider; the payment processing solution provider generates a payment account identifier 412 that may be stored in the safe storage and is returned to the entitlement system 115 for subsequent referencing of the payment account 415 for a payer 111 or payee 112. Subsequent entry of other payment source or target 406 data entered by a payer 111 or payee 112 utilize the same payment account 407 and payment account ID 412 previously created, through lookup of the account binding data 413 in the entitlement data store 409, which binds the entitlement account 408 with the payment account 407.

The entitlement system payment account 415 may also be designated to retain a monetary balance and for conducting payments from a payer 111 to a payee 112.

A payer 111 and/or payee 112 may not have an assigned payment source or target at the time of payment or mobile data connectivity, but may still conduct a payment through a balance held in their entitlement account.

If a payment processing solution provider is not used, payment source or target data may be stored in separate safe storage medium (e.g., in a PCI DSS compliant entitlement subsystems and data stores) or in the payment processing system's subsystems and databases. In these embodiments of the invention, the entitlement subsystems communicate payment transactions directly with the payment processing systems. For example, VISA® provides an API for direct processing of credit card payments.

Anonymous Payment Negotiation

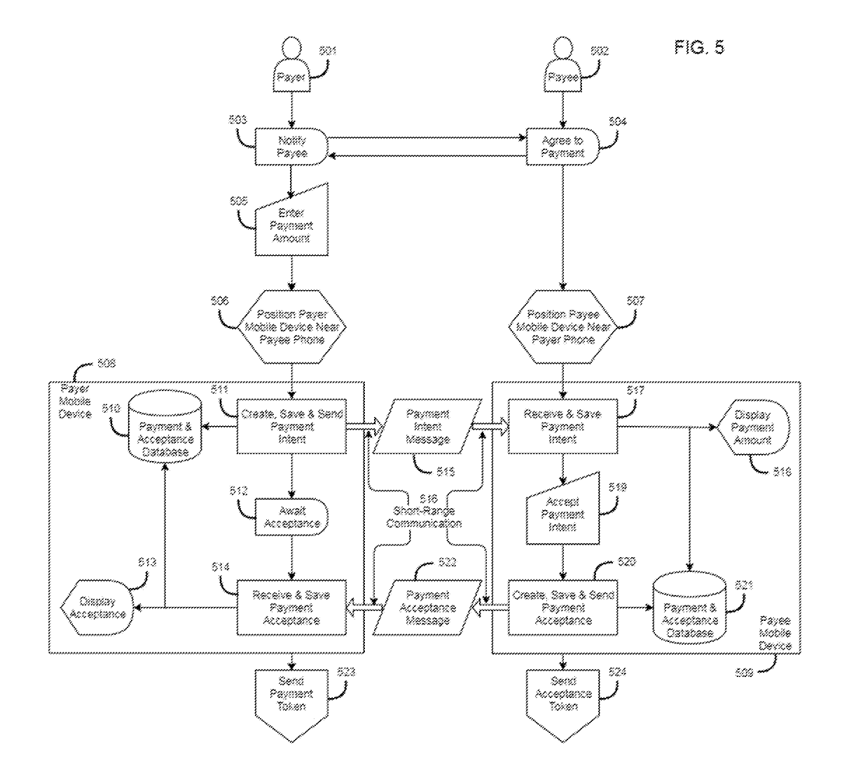

FIG. 5 shows a flowchart of a method for negotiating an anonymous payment that may be used as a preferred embodiment of the invention. A payer 501 (shown in FIG. 1 as 111) with an intention to make an anonymous payment to a payee 502 gets the attention of the payee 502 (e.g., verbally) to notify the payee 503 of a desire to make an anonymous payment to the payee 502. The payee 502 agrees to the anonymous payment 504. The payer 501 may manually start a software application that adheres to the embodiments of this invention on their mobile device 508 and enters a payment amount 505. The payee 502 may also manually start a software application that adheres to the embodiments of this invention on their mobile device 509 and positions their mobile device 506 near the payer mobile device 507; depending on the form of short-range communication 516 being used (e.g., NFC) by the payer 501 and payee 502, the software application may start on its own when the payer and payee mobile devices 508, 509 are brought in close proximity to one another. A payment intent message 515 is then created, saved 511 in the payer mobile device 508 payment and acceptance data store 510 and sent to the payee mobile device 509 using the configured short-range communication technique; the payment intent message, in a preferred embodiment, is comprised of the payment amount and a Universally Unique ID (UUID) used for subsequent verification; a default currency common between the payer and payee mobile devices 508, 509 is already configured.

It should be noted that in certain embodiments, the payment amount need not be part of the payment intent message and can be sent directly to the entitlement system and may be provided (or not) to the payee after processing by the entitlement system. In these embodiments, it is also possible for the payer to identify and provide the payment amount at a later time, such as when the payer wishes to commit the payment transaction.

Various forms of short-range communication 516 may be used. For example, the payer 501 may configure the software application on their mobile device 508 to display a barcode 516 when sending the payment intent message 515 to a payee mobile device 508, in which case the payee 502 may configure their software application to scan the barcode 516 displayed on the payer's mobile device 508. The software application on the payee mobile device 509 then decodes the scanned barcode into the payment intent message 517, saves it in the payment and acceptance data store 521 and displays the payment amount 518 on the payee mobile device 509. In another example, the payer 501 may configure the software application on their mobile device 508 to use NFC to transmit the payment intent message 515 from the payer mobile device 508 to the payee mobile device 509, in which case the payee mobile device may automatically detect the NFC signal 516 and automatically start the software application. The payee mobile device 509 receives the payment intent message 517 using NFC 516, saves it in the payment and acceptance data store 521 and displays the payment amount 518 on the payee mobile device 509.

The software application on the payee mobile device 509 then prompts the payee for acceptance of the payment amount 519 while the payer 501 awaits the payee's acceptance 512. Upon payee acceptance of the payment amount 519, the software application on the payee mobile device 509 creates a payment acceptance message 520, saves it to the payment and acceptance data store 521 on the payee mobile device 509, and transmits it using the configured short-range communication 516 to the payer mobile device 508. The payer mobile device 508 receives the payment acceptance message 522 using the configured short-range communication 516, saves 514 it to the payment and acceptance data store 510, and displays 513 it on the payer mobile device 508.

The software application on the payer mobile device 508 then processes the payer payment 523 and the software application on the payee mobile device 509 processes the payee receipt 524.

It should be noted that in certain embodiments of the present invention, certain steps from FIG. 5 are or can be made optional. For instance, in certain embodiments, the payment intents need not be stored, such as when the intent may be transmitted to the entitlement system. Still, in further embodiments, transmittal or display of the payment amount to the payee may not be required. For instance, the payee may be optionally not informed of the actual payment amount. In certain embodiments, the payee may be merely notified that a payment was intended to be made, but not the actual value of that payment. This may be useful in situations where it is better for the payer not to notify the payee of the actual amount, which may be less or more than what the payee was actually expecting.

Correlate Payment and Acceptance

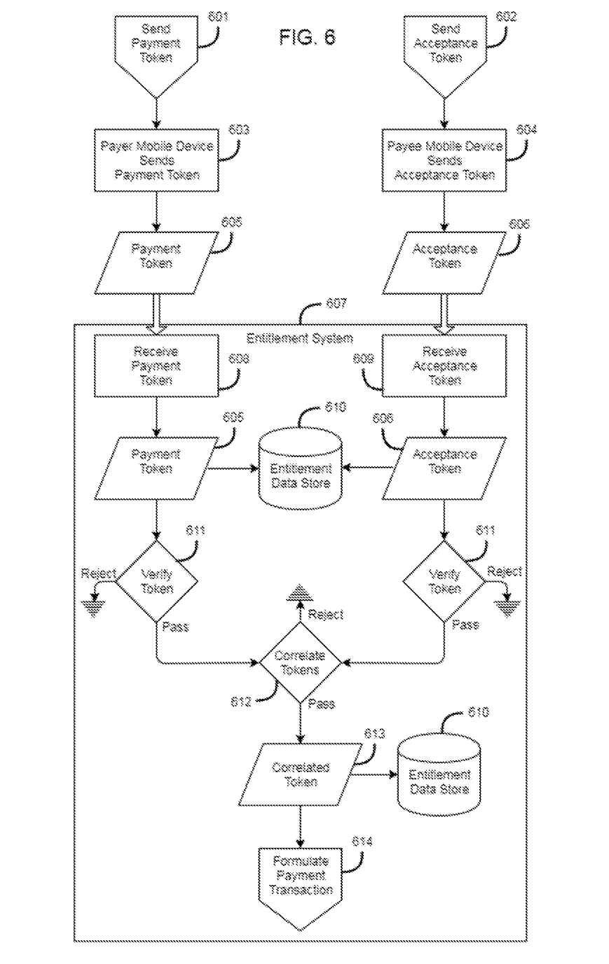

FIG. 6 is a flowchart of the correlation of payment and acceptance tokens that may be used as a preferred embodiment of the invention. After a payer 501 and payee 502 have negotiated a payment as illustrated in FIG. 5, a payer mobile device 508 securely sends a payment token 603, minimally comprised of a payment amount 505, an UUID, and a payer identifier such as the payer name, to an entitlement system 607, and a payee mobile device 509 securely sends an acceptance token 604, in one embodiment, said acceptance token, in a preferred embodiment, minimally comprised of a payment amount 505, an UUID, and a payee identifier such as the payee name, to an entitlement system 607. The anonymous payments software application on a mobile device 113 or 114, 508 or 509 may not have immediate access to a data network 108 for sending a payment token 603 or acceptance token 604 to an entitlement system 607, in which case the payment token data 605 or the acceptance token data 606, are queued in the payment and acceptance database 510 or 521, respectively, until such time that a data network 108 becomes accessible; once a data network 108 becomes accessible, the queued token is sent to an entitlement system 607. A payment token 605 or acceptance token 606 may also have an expiration time such that it is permanently rejected if it is not sent within a certain time period.

As a note, while in preferred embodiments payment tokens comprises a payment amount, in other embodiments, payment tokens, either from payer or payee may not require a payment amount. For instance, a payee token may not require a payment amount and instead may be comprised of a UUID that will link the transaction to a payment amount submitted by the payer. In other embodiments, the payment token may be devoid of payment amount, and rather payment amount may be referenced to a fixed payment amount saved or otherwise stored in the system (e.g., standard $1 tip, $5 tip). One of ordinary skill in the art would appreciate that there are numerous manners in which payment amounts could be determined and placed upon any given transaction, and embodiments of the present invention are contemplated for use with any such manner of applying payment amounts.

The entitlement system 607 may receive a payment token 608, store the payment token 605 in an entitlement data store 610, and verify the payment token 605 for authenticity; the payment token 605 may proceed to the Correlate Tokens 613 step if it passes authenticity, otherwise it is rejected. Similarly, the entitlement system 607 may receive an acceptance token 606, store the acceptance token 606 in an entitlement data store 610, and verify the acceptance token 606 for authenticity; the acceptance token 606 may proceed to the Correlate Tokens 613 step if it passes authenticity, otherwise it is rejected.

The Correlate Tokens 613 step may analyze payment tokens and acceptance tokens for matching UUIDs; if a matching UUID is found, the corresponding correlated payment token 605 and acceptance token 606 data may be combined and stored in the entitlement data store 610, the payment token 605 payer identification information may be looked up in the entitlement data store 610 to obtain the unique payer payment account identifier 411 in FIG. 4 and payer payment source or target metadata 410, and the acceptance token 606 payee identification information may be looked up in the entitlement data store 610 to obtain the unique payee payment account identifier 411 and payee payment target metadata 410. The correlated token may then be used to formulate a payment transaction 614. If a payment token 605 is not eventually correlated 612 with an acceptance token 606 as determined by an expiration time, the unmatched token is permanently rejected upon expiration.

Process Payment Transaction

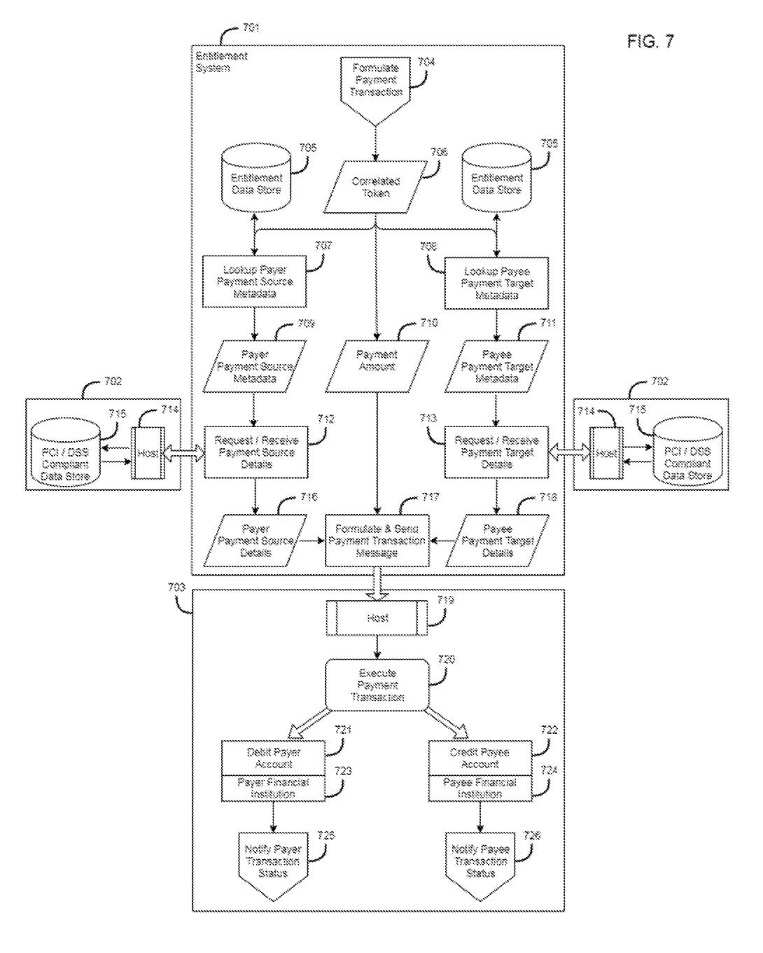

FIG. 7 is a flowchart of the formulation and execution of a financial payment transaction that may be used as a preferred embodiment of the invention. The correlated token 706 (613 in FIG. 6) data may be used to lookup the payer payment source metadata 707 (410 in FIG. 4) and the payee payment target metadata 708 (410 in FIG. 4). The payer payment source metadata 709 may then be used to request and receive the payer payment source details 712 via a host 714 computer with direct or indirect access to the safe storage medium (e.g., PCI DSS compliant data store) 715 that stores the payer payment source details. Similarly, the payee payment target metadata 711 may then be used to request and receive the payee payment target details 713 via a host 714 computer with direct or indirect access to the safe storage medium (e.g., PCI DSS compliant data store) 715 that stores the payee payment target details. The payer payment source details 716 and the payee payment target details 718 are then combined with the payment amount 710 to formulate the payment transaction message 717 and securely send it to the payment processing system 703 for processing. The payment processing system may use a host computer 719 to receive the payment transaction message and/or server computers to execute a payment transaction 720 representative of the data in the payment transaction message. Upon execution of the payment transaction 720, the payer account corresponding to the payment source is debited 721 by the payment amount 710, and the payee account corresponding to the payment target is credited 722 by the payment amount 710. The payer and payee are then notified of the status 725, 726 of the payment through one or more various means, including a notification on their mobile device or a record in their entitlement account 408.

The debit of the payer account 721 occurs at the payer's financial institution 723, which provides the status of the executed payment transaction 720. Likewise, the credit of the payee account 722 occurs at the payee's financial institution 724, which provides the status of the executed payment transaction 720.

The host 714 computer and safe storage (e.g., PCI DSS compliant data store) 715 may be managed by a payment processing solution provider or a financial payment system.

Payment source details 712 or payment target details 713 may be requested through what is commonly termed an Authorization and Capture.

One of the fundamental aspects of anonymity provided in preferred embodiments of the present invention is achieved through the separation of the payer intent data and the payee acceptance data. One of the important aspects here is that neither the payer nor the payee have access or exposure to personal or financial/banking information of the other. This is achieved through the fact that their respective mobile devices, entitlement accounts, or payment accounts, do not have personal information about the other person, and the correlation of the payment and acceptance data on entitlement system 607 components are not exposed, visible or accessible to the payer 111 or payee 112. The payer and payee payment accounts and payment sources or targets also do not expose the corresponding payee or payer, respectively, as the financial payment transaction 720 may be recorded with an arbitrary name, such as a business name, that does not in any way reflect the payer or payee.

Embodiments of the invention have several advantages, in that by allowing for rapid and anonymous payment transactions, the safety and security of cash-like micro-transactions (e.g., tipping) can be implemented solely through use of mobile computing devices, and supported on the backend in conjunction with modern electronic payment systems (e.g., credit card transactions, cryptocurrency transactions). Since embodiments of the present invention allow for truly anonymous electronic transactions, there is little to no security risk when completing such a transaction. Given security measures in place on such mobile computing devices, security is actually enhanced over cash or other physical payment instruments, as loss of those physical payment instruments (even credit cards) can be used by others and in many cases, unrecoverable (such as lost cash).

By providing a system and method for implementing a transaction process that does not allow for exposure of payer or payee identifying information to be made available to the other, or part of any over the air (OTA) communication, there is simply no way for the identify or other personal information (such as banking information) of payer or payee to be exposed. Advantageously, users are provided with an end-to-end secure payment transaction system that allows for quick and easy processing of anonymous transactions.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data. In a preferred embodiment of the present invention, the data store may be a relational database, working in conjunction with a relational database management system (RDBMS) for receiving, processing and storing data. In another preferred embodiment, the data store may be a non-relational data store, such as no-SQL. In a preferred embodiment, the data store may comprise one or more databases for storing information related to the processing of moving information and estimate information as well one or more databases configured for storage and retrieval of moving information and estimate information. One of ordinary skill in the art would appreciate there are numerous configurations that would work with embodiments of the present invention, and embodiments of the present invention are contemplated for use with any appropriate configurations.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

A recitation of “a”, “an”, or “the” is intended to mean “one or more” unless specifically indicated to the contrary.

1. A computer implemented method for conducting anonymous payments, said method comprising the steps of:
receiving, at an entitlement system, a payment token from a payer device,
verifying, at said entitlement system, legitimacy of said payment token,
correlating said payment token with an acceptance token received by said entitlement system from a payee device,
retrieving, from the entitlement system, a first publicly-safe data and identifier information for a payer associated with the payer device;
retrieving from the entitlement system, a second publicly-safe data and identifier for a payee associated with the payee device
formulating a payment transaction message using the first and second publicly-safe data and identifiers;
transmitting said payment transaction message to a financial processing system;
receiving, at said entitlement system, payment transaction confirmation from said financial processing system;
formulating, at said entitlement system, a payment status message, wherein said payment status message comprises a status of a payment to be made by said payer to said payee; and
transmitting said payment status message to one or more of said payer device and said payee device.

2. The method of claim 1, wherein the payment token and acceptance token use an embedded matching Universally Unique Identifier (UUID).

3. The method of claim 1, wherein said payment token is generated after a payment handshake is completed involving said payer device and said payee device.

4. The method of claim 3, further comprising the step of waiting until a wide area network is available prior to sending the payment token from the payer mobile device to the entitlement system.

5. The method of claim 1, further comprising the steps of:
transmitting, from the payer device, a payment intent message to the payee device,
wherein the payment intent message is sent via a first short-range data communication means when the payer device and payee device are in close proximity to one another; and
transmitting, from the payee device, a payment acceptance message via a second short-range communications means, to said payer device.

6. The method of claim 5, further comprising the steps of:
generating said payment token, based at least in part on information associated with said payment intent message and said payment acceptance message.

7. The method of claim 5, wherein said payment intent message comprises a payment amount and a universally unique identifier.

8. The method of claim 5, further comprising the steps of:
registering said payer into said entitlement system, thereby creating a payer entitlement account, enabling subsequent anonymous payment of funds electronically using said payer device, wherein registration of said payer entitlement account comprises account data sufficient to enable payment of funds by a first corresponding financial transaction; and
registering said payee into said entitlement system, thereby creating a payee entitlement account, enabling subsequent anonymous receipt of funds electronically using said payee device, wherein registration of said payee entitlement account comprises account data sufficient to enable receipt of funds by a second corresponding financial transaction.

9. The method of claim 8, wherein information associated with said payee account and said payer account are securely sent to the financial processing system for storage in a safe storage medium and are bound to the corresponding payer or payee entitlement account through publically-safe data and identifiers recognized by the financial processing system.

10. The method of claim 1, further comprising the steps of:
receiving a payment request message from said payee device, at said payer device; and
transmitting, from the payer device, a payment intent message in response to the payment request message, to the payee device,
wherein the payment request message and payment intent message are sent via a short-range data communication means when the payer device and payee device are in close proximity to one another; and
transmitting, from the payee device, a payment acceptance message, to said payer device.

11. A computer implemented system for conducting anonymous payments, said system comprising:
an entitlement system adapted to process information related to anonymous payments;
a processor, operably coupled to said entitlement system;
a memory that is not a transitory propagating signal, the memory connected to the processor and encoding computer readable instructions, including processor executable program instructions, the computer readable instructions accessible to the processor, wherein the processor executable program instructions, when executed by the processor, cause the processor to perform operations comprising:
receiving, at an entitlement system, a payment token from a payer device,
verifying, at said entitlement system, legitimacy of said payment token,
correlating said payment token with an acceptance token received by said entitlement system from a payee device,
retrieving, from the entitlement system, a first publicly-safe data and identifier information for a payer associated with the payer device;
retrieving from the entitlement system, a second publicly-safe data and identifier for a payee associated with the payee device
formulating a payment transaction message using the first and second publicly-safe data and identifiers;
transmitting said payment transaction message to a financial processing system;
receiving, at said entitlement system, payment transaction confirmation from said financial processing system;
formulating, at said entitlement system, a payment status message, wherein said payment status message comprises a status of a payment to be made by said payer to said payee; and
transmitting said payment status message to one or more of said payer device and said payee device.

12. The system of claim 11, wherein the payment token and acceptance token use an embedded matching Universally Unique Identifier (UUID).

13. The system of claim 11, wherein said payment token is generated after a payment handshake is completed involving said payer device and said payee device.

14. The system of claim 13, wherein the processor executable program instructions, when executed by the processor, cause the processor to perform further operations comprising waiting until a wide area network is available prior to sending the payment token from the payer mobile device to the entitlement system.

15. The system of claim 11, wherein the processor executable program instructions, when executed by the processor, cause the processor to perform operations comprising:
transmitting, from the payer device, a payment intent message to the payee device,
wherein the payment intent message is sent via a first short-range data communication means when the payer device and payee device are in close proximity to one another; and
transmitting, from the payee device, a payment acceptance message via a second short-range communications means, to said payer device

16. The system of claim 15, wherein the processor executable program instructions, when executed by the processor, cause the processor to perform operations comprising:
generating said payment token, based at least in part on information associated with said payment intent message and said payment acceptance message.

17. The system of claim 15, wherein said payment intent message comprises a payment amount and a universally unique identifier.

18. The system of claim 15, wherein the processor executable program instructions, when executed by the processor, cause the processor to perform operations comprising:
registering said payer into said entitlement system, thereby creating a payer entitlement account, enabling subsequent anonymous payment of funds electronically using said payer device, wherein registration of said payer entitlement account comprises account data sufficient to enable payment of funds by a first corresponding financial transaction; and
registering said payee into said entitlement system, thereby creating a payee entitlement account, enabling subsequent anonymous receipt of funds electronically using said payee device, wherein registration of said payee entitlement account comprises account data sufficient to enable receipt of funds by a second corresponding financial transaction.

19. The system of claim 18, wherein information associated with said payee account and said payer account are securely sent to the financial processing system for storage in a safe storage medium and are bound to the corresponding payer or payee entitlement account through publically-safe data and identifiers recognized by the financial processing system.

20. The system of claim 11, wherein the processor executable program instructions, when executed by the processor, cause the processor to perform operations comprising:
receiving a payment request message from said payee device, at said payer device; and
transmitting, from the payer device, a payment intent message in response to the payment request message, to the payee device,
wherein the payment request message and payment intent message are sent via a short-range data communication means when the payer device and payee device are in close proximity to one another; and
transmitting, from the payee device, a payment acceptance message, to said payer device.
